(19) United States
(12) Patent Application Publication
(10) Pub. No.: US 2015/0076219 A1
(43) Pub. Date: Mar. 19, 2015

(54) TACTILE ANTI-FORGERY METHOD USING RANDOM EMBOSS

(71) Applicants: Fu-Pi Pao, Taipei City (TW); San-Yuan Wu, Taipei City (TW); Kuan-Ying Pao, Taipei City (TW)

(72) Inventors: Fu-Pi Pao, Taipei City (TW); San-Yuan Wu, Taipei City (TW); Kuan-Ying Pao, Taipei City (TW)

(73) Assignee: SENSE DIGITAL CO., LTD., Taipei City (TW)

(21) Appl. No.: 14/466,905

(22) Filed: Aug. 22, 2014

(30) Foreign Application Priority Data
Sep. 14, 2013 (TW) 102133305

(51) Int. Cl. G06F 17/30; G06Q 30/00; G06F 21/64

(52) U.S. Cl. CPC G06F 17/30879; G06F 17/30887; G06F 21/64; G06Q 30/0185
USPC 235/375; 707/758

(57) ABSTRACT

A tactile anti-forgery method using random raised structures allows a manufacturer to generate labels that can be attached to different products, wherein each label has a unique label serial number, connection information for connecting to a default system database and at least one randomly arranged raised structure protruding from the surface of the label. The label serial numbers and corresponding information such as the distributed location of the raised structures are established in the system database. A user may first confirm the existence of the raised structures by touching the label, and then connect to the system database using the connection information to look up information such as the distributed location of the raised structures corresponding to the label serial number on the label, and finally compare the obtained information and the actual raised structures to see if they are correctly distributed.

### BACKGROUND OF THE INVENTION

1. Field of the Invention

The invention relates to a tactile anti-forgery method using random raised structures, and more particularly, to an improved tactile anti-forgery method using random tactile raised structures on labels in conjunction with conventional anti-forgery techniques.

2.Description of the Prior Art

Conventional carrier structures (labels) with anti-forgery identification features, for example, as seen in CN Patent Application No. 97126167.9 titled “NATURAL ANTI-FORGERY METHOD”, are made into fixed-sized (square, circular or other shapes) sheets with natural materials such as wood or stone. Each of these inherently characteristic sheets is individually assigned with a random number using a computer, and then the number is primed on the sheet. Then, the textures and patterns of the sheets are scanned. and filed for future inquiries.

This type of identification technique is based on the texture of the natural materials (wood or stone). However, under the current manufacturing environment with advanced photographic reproduction techniques, the fact that this type of identification method relies on visual identification of the features may not achieve the anticipated anti-forgery effect.

CN Patent Application No. 99801139.8 titled “STRUCTURAL TEXTURE ANTI-FORGERY METHOD” uses materials having unambiguous and random structural textures as anti-forgery identification objects that utilize the random structural textures as anti-forgery information. The anti-forgery information are scanned or recorded with a scanning device and stored in a computer identification database. Consumers may obtain information about the structural textures via communication tools such as phones, faxes or networked computers to verify the genuineness of the texture information of the products.

The abovementioned random structural texture refers to a random texture integrated into an artificial carrier structure. For example, filaments are added into paper pulp in which the distribution of the filaments is used as anti-forgery information. However, this type of anti-forgery labels can be counterfeited by providing similar visual effects of the features using the current printing (including stamping) techniques, such that an inquirer may find it difficult to distinguish between a printed counterfeit and filaments unless the filaments are stripped off the carrier. Doing so requires time and effort and may easily damage the anti-forgery label.

Moreover, in CN Patent Application No. 200910135421.4 titled “ANTI-FORGERY METHOD OF STRUCTURAL TEXTURE”, an anti-forgery mark is numbered and provided with a random texture given by angle-dependent color-shifting fibers. The feature of this random texture and the number are stored in a database for consumers to verify the genuineness of the random texture feature. Since it is impossible to counterfeit the angle-dependent color-shifting fibers by printing, the anti-forgery effectiveness of this type of texture is largely improved.

However, the anti-forgery method just mentioned can still be counterfeited to some extent with the current photocopying printing techniques, causing visual confusion to an inquirer, such that the inquirer may not immediately ascertain if the label is a printed counterfeit. This is a practical shortcoming.

In view of the shortcomings in the conventional planar anti-forgery mechanisms using random textures, the present invention is proposed to provide improvements that address these shortcomings.

### SUMMARY OF THE INVENTION

One main objective of the present invention is to provide a tactile anti-forgery method using random raised structures that offers a tactile sensation to users through randomly arranged raised structure(s) on an anti-forgery label to overcome the shortcoming of causing visual confusion to the users by forging traditional planar anti-forgery mechanisms with photographic reproduction techniques.

Another objective of the present invention is to provide a tactile anti-forgery method using random raised structures that can be combined with existing anti-forgery mechanism(s) in practice, such that there is no large difference in the overall operation procedure. This not provides ease of use, but also achieves a better anti-forgery effect.

In order to achieve the above objectives and efficacies, the technical means employed by the present invention may include: a step of “generating a plurality of labels to be attached to products, wherein each label has a unique label serial number, connection information and at least one randomly arranged surface raised structure thereon”, wherein a manufacturer generates various labels to be attached to different products, each label has a unique label serial number, connection information fir connecting to a default system database and at least one randomly arranged raised structure protruding from the surface of the label; a step of “establishing distribution information of the raised structures corresponding to the various label serial numbers in the system database”, wherein various label serial numbers and information including the distribution information of the various corresponding raised structures are established in the system database; a step of “a user confirming the existence of the at least one raised structure by touching the at least one raised structure on a label”; a step of “connecting to the system database to obtain the distribution information of the at least one raised structure corresponding to the label serial number”, wherein the user connects to the system database through a connection process using the connection information, and looks up information including the distribution of the at least one raised structure corresponding to the serial number on the label; and a step of “the user comparing the obtained information and the at least one actual raised structure on the label to see if it is correctly distributed”, wherein the user compares the locations of the actual one or more raised structures on the label and the distribution information of the at least one raised structure provided by the system database and to see if they are the same, thereby achieving the effect of anti-forgery.

Based on the method above, the content of the connection information may be selected from at least one of the following: a Uniform Resource Locator (URL), a phone number, the name of an inquiry database platform or system, the name of an application on a default terminal and a download URL of the application.

Based on the method above, the connection information is an identification code (ID), and the connection process obtains and analyzes the ID via a terminal, such that the terminal automatically connects to the system database.

Based on the method above, the ID is selected from at least one of the following: a barcode, a two-dimensional barcode, QR code and Data Matrix code, and the terminal obtains the ID by photography.

Based on the method above, the connection information is stored in a default radio frequency ID (RFID) element, and the connection process obtains the connection information stored. within the RFID element with a RFID reading device.

Based on the method above, the distribution information of the at least one raised structure is established in the system database by scanning.

Based on the method above, the distribution information of the raised structure is a planar scan image, and a text description of the appearance of the raised structure is also included.

Based on the method above, the distribution information of the raised structure is information. regarding the distributed location of the raised structure generated with a pressure- or touch-sensitive scanning machine.

Based on the method above, the distribution information of the raised structure is a three-dimensional (3D) scan image of the distributed location of the raised structure generated with a 3D scanning machine.

Based on the method above, the distribution information of the raised structure is information regarding the distributed location of the raised structure generated with a thickness scanning machine.

The objectives, efficacies and features of the present invention can be more fully understood by referring to the drawing as follows:

### BRIEF DESCRIPTION OF THE DRAWINGS

FIG. 1 is a flowchart illustrating a method of the present invention.

### DETAILED DESCRIPTION OF THE PREFERRED EMBODIMENTS

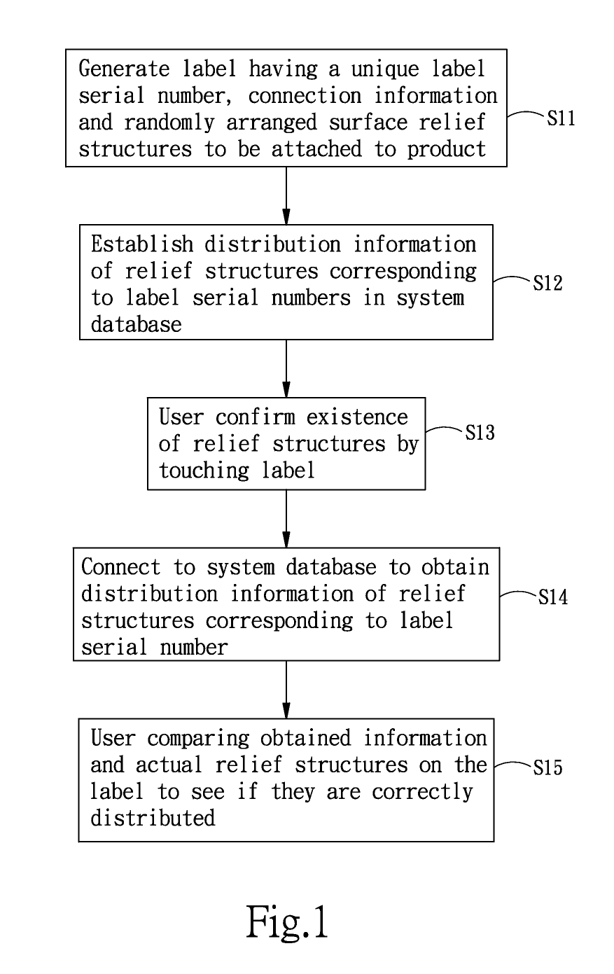

Referring to FIG. 1, a method of the present invention mainly includes the following steps: (S11) generating a plurality of labels that can be attached to products, wherein each label has a unique label serial number, connection information and at least one randomly arranged surface raised structure thereon; (S12) establishing distribution information of the raised structures corresponding to the various label serial numbers in a system database; (S13) a user confirming the existence of the at least one raised. structure by touching the at least one raised structure on a label; (S14) connecting to the system database to obtain the distribution information of the at least one raised structure corresponding to the label serial number; and (S15) the user comparing the obtained information and the at least one actual raised structure on the label to see if it is correctly distributed.

In step S11 of “generating a plurality of labels that can be attached to products, wherein each label has a unique label serial number, connection information and at least one randomly arranged surface raised structure thereon”, a manufacturer generating various labels that can be attached to different products. Each label has a unique label serial number, connection information for connecting to a default system database and at least one randomly arranged raised structure protruding from the surface of the label. In one preferred embodiment, the connection information is a URL directly printed on the label, the name of an inquiry database platform (or system) or a phone number; or an identification code (ID) (e.g. a barcode, a two-dimensional barcode, QR code or Data Matrix code) and the like. Upon analyzing the ID, information such as an URL, a phone number, the name of an application on the default terminal and the download URL of the application can be obtained. The raised structure can be in the form of a round bump, a rod, a cone or any other protruding structure that can be clearly felt through touching.

in step S12 of “establishing distribution information of the raised structures corresponding to the various label serial numbers in a system database”, various label serial numbers and information such as the distribution information of the various corresponding raised structures are established in a system database. The distribution information of the raised structures are established in the system database by scanning, for example, using a planar scanning machine to scan the raised structure into a planar scan image, and including a text description of the appearance of the raised structure.

A pressure- or touch-sensitive scanning machine can also be used to scan the raised structures in order to generate the distribution information of the various raised structures.

A three-dimensional (3D) scanning machine can also be used to scan the raised structures in order to generate 3D images of the distribution information of the various raised structures.

A thickness scanning machine can also be used to scan the raised structures in order to generate 3D images of the distribution information of the various raised structures.

In step S13 of “user confirming the existence of the at least one raised structure by touching the at least one raised structure on a label”, a user touches the label to confirm that there is indeed a protrusion on the label to validate in advance the existence of the raised structure on the label.

In step S14 of “connecting to the system database to obtain the distribution information of the at least one raised structure corresponding to the label serial number”, the user connects to the system database through a connection process using the connection information, and looks up information such as the distribution of the raised structure corresponding to the serial number on the label. In one preferred embodiment, if the connection information is a URL directly printed on the label, the name of an inquiry database platform (or system) or a phone number, then the user may connect to the system database via a terminal or phone and obtain the distribution information of the at least one raised structure; if the connection information is an ID (e.g. a barcode, a two-dimensional barcode, QR code or Data Matrix code), then a terminal with a camera can be used to obtain the ID by taking a photo of the ID, and after analyzing the ID, information such as an URL, a phone number, the name of an application on the default terminal and the download URL of the application can be obtained, and the terminal can automatically and directly or indirectly connect to the system database using the above information.

In the above structure(s), a radio frequency ID (RFID) element storing the connection information can be provided on the label, and the terminal may use a RFID reading device to obtain the connection information stored within the RFID element and then automatically connect to the system database.

In step S15, “the user comparing the obtained information and the at least one actual raised structure on the label to see if it is correctly distributed”, the user compares the obtained distribution information of the at least one raised structure and the shapes and locations of the actual raised structure(s) on the label. If they match, then the user can determine that the label (product) is genuine. As such, an improved anti-forgery effect can be achieved.

The above method of the present invention, when put into practice, can be implemented in conjunction with traditional anti-forgery mechanisms such as those using planar image, texture, serial number management or color shifting to increase the difficulty and complexity of counterfeiting to achieve a better anti-forgery effect.

In summary, the shortcoming of causing confusions to observers by producing visually similar labels using photographic reproduction techniques in the prior art is alleviated with the tactile anti-forgery method using random raised structures of the present invention by further providing a tactile sensation to users with the use of random raised structures to increase the effect of anti-forgery. In view of this, the present invention is submitted to be novel and non-obvious and a patent application is hereby filed in accordance with the patent law. It should be noted that the descriptions given above are merely descriptions of preferred embodiments of the present invention, various changes, modifications, variations or equivalents can be made to the invention without departing from the scope or spirit of the invention. It is intended that all such changes, modifications and variations fall within the scope of the following appended claims and their equivalents.

1. A tactile anti-forgery method using random raised structures, comprising:
a. generating a plurality of labels to be attached to products, wherein each label has a unique label serial number, connection information and at least one randomly arranged surface raised structure thereon, wherein a manufacturer generates various labels to be attached to different products, each label has a unique label serial number, connection information for connecting to a default system database and at least one randomly arranged raised structure protruding from the surface of the label;
b. establishing distribution information of the raised structures corresponding to the various label serial numbers in the system database, wherein various label serial numbers and information including the distribution information of the various corresponding raised structures are established in the system database;
c. a user confirming the existence of the at least one raised structure by touching the raised structure on a label;
d. connecting to the system database to obtain the distribution information of the at least one raised structure corresponding to the label serial number, wherein the user connects to the system database through a connection process using the connection information, and looks up information including the distribution of the at least one raised structure corresponding to the serial number on the label; and
e. the user comparing the obtained information and the at least one actual raised structure on the label to see if it is correctly distributed, wherein the user compares the locations of the actual one or more raised structures on the label and the distribution information of the at least one raised structure provided by the system database and to see if they match.

2. The tactile anti-forgery method using random raised structures as claimed in claim 1, wherein the content of the connection information is selected from at least one of the following: a Uniform Resource Locator (URL), a phone number, the name of an inquiry database platform or system, the name of an application on a default terminal and a download URL of the application.

3. The tactile anti-forgery method using random raised structures as claimed in claim 2, wherein the connection information is an identification code (ID), and the connection process obtains and analyzes the ID via a terminal, such that the terminal automatically connects to the system database.

4. The tactile anti-forgery method using random raised structures as claimed in claim 3, wherein the ID is selected from at least one of the following: a barcode, a two-dimensional barcode, QR code and Data Matrix code, and the terminal obtains the ID by photography.

5. The tactile anti-forgery method using random raised structures as claimed in claim 1, wherein the connection information is stored in a default radio frequency ID (RFID) element, and the connection process obtains the connection information stored within the RFID element with a RFID reading device.

6. The tactile anti-forgery method using random raised structures as claimed in claim 1, wherein the distribution information of the at least one raised structure is established in the system database by scanning.

7. The tactile anti-forgery method using random raised structures as claimed in claim 6, wherein the distribution information of the raised structure is a planar scan image, and a text description of the appearance of the raised structure is also included.

8. The tactile anti-forgery method using random raised structures as claimed in claim 6, wherein the distribution information of the raised structure is information regarding the distributed location of the raised structure generated with a pressure- or touch-sensitive scanning machine.

9. The tactile anti-forgery method using random raised structures as claimed in claim 6, wherein the distribution information of the raised structure is a three-dimensional (3D) scan image of the distributed location of the raised structure generated with a 3D scanning machine.

10. The tactile anti-forgery method using random raised structures as claimed in claim 6, wherein the distribution information of the raised structure is information regarding the distributed location of the raised structure generated with a thickness scanning machine.
